(19) United States
(12) Patent Application Publication
(10) Pub. No.: US 2009/0128812 A1
(43) Pub. Date: May 21, 2009

(54) Method of reducing peak broadening in analytical measurements

(76) Inventors: Richard A. Keller, Los Alamos, NM (US); Andrew Cameron Beveridge, Los Alamos, NM (US); Thomas M. Yoshida, Los Alamos, NM (US); Lawrence Riley Pratt, Los Alamos, NM (US); James Hubert Jett, Albuquerque, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 12/286,944

(22) Filed: Oct. 2, 2008

Related U.S. Application Data
(60) Provisional application No. 60/998,400, filed on Oct. 10, 2007.

(51) Int. Cl. G01N 21/47

(52) U.S. Cl. 356/338

(57) ABSTRACT

A method of reducing peak width in flow-through analytical instrumentation measurements, comprising introducing a sample into an analytical instrument; recording the time required for a plurality of individual analytes within the sample to travel a known distance between a first point and a second point within the analytical instrument to produce a plurality of travel times; recording the time required for a plurality of individual analytes within a sample to travel a known distance between a first point and a second point to produce a plurality of travel times; dividing the travel times into a plurality of groups comprising a fixed number of travel times; assigning a ranking to the travel times within a group; selecting from each group at least one travel time to produce a set of selected travel times; and producing from the set of selected travel times an output signal in the form of a peak.

### RELATED APPLICATIONS

This application claims the benefit of Provisional Application Ser. No. 60/998,400 filed on Oct. 10, 2007.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

The present invention relates to a method of decreasing peak broadening in flow-through analytical instrumentation measurements, and to a software encoded algorithm of the method.

### BACKGROUND OF THE INVENTION

In flow-through analytical techniques, for example, liquid chromatography, the width of the output signal, or peak, increases as the length of the analysis is increased. This phenomenon, known as “peak broadening,” has a detrimental effect on detection and identification of analytes. A broad peak may produce a signal at or below the detection limit, as a finite amount of output signal is spread out over a longer time period. In addition, what appears to be a single broad peak may in fact comprise multiple species which are unable to be resolved due to the broadness of the individual peaks. A need exists, therefore, to reduce the broadening effect of analytical output signals, in particular of those signals corresponding to analytes that are in transit to the detector for longer periods of time.

### SUMMARY OF THE INVENTION

The present method meets the aforementioned need by applying statistical analysis to single molecule detection measurements. The time that is required for individual analytes to travel between two points of detection, which have single molecule detection capability, is recorded to produce a set of timepoints, (i.e., crossing times). The timepoints are processed according to a statistical analysis algorithm which may utilize extreme value statistics guided by the inverse Gaussian distribution. Additional advantages of the method described herein may also include a means for a more precise determination of the diffusion coefficient of an analyte, a smaller required sample size, and a reduction in analysis time. The latter may be particularly important for high-throughput analytical systems.

The present invention provides in one embodiment a method of reducing peak width in flow-through analytical instrumentation measurements, comprising introducing a sample into an analytical instrument; recording the time required for a plurality of individual analytes within the sample to travel a known distance between a first point and a second point within the analytical instrument to produce a plurality of travel times; recording the time required for a plurality of individual analytes within a sample to travel a known distance between a first point and a second point to produce a plurality of travel times; dividing the travel times into a plurality of groups comprising a fixed number of travel times; assigning a ranking to the travel times within a group; selecting from each group at least one travel time to produce a set of selected travel times; and producing from the set of selected travel times an output signal in the form of a peak. In one embodiment, the method is encoded into software for use with the flow-through analytical instrumentation.

### BRIEF DESCRIPTION OF THE DRAWINGS

FIG. 1 depicts four output signals (peaks) (a)-(d) produced on a conventional flow-through instrument to which no extreme value statistical analysis has been applied. The peaks correspond to four different analytes (a)-(d), each having a different diffusion coefficient (D), all in units of cm²/s.

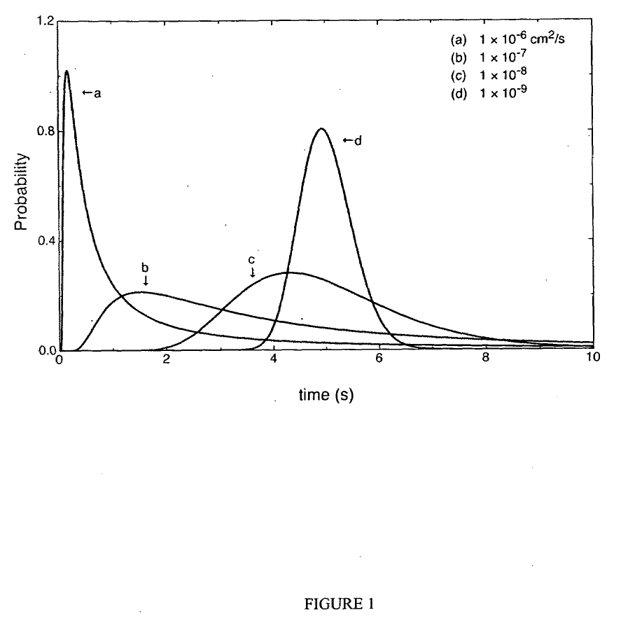

FIG. 2 depicts output signals from the same four analytes as depicted in FIG. 1 to which extreme value statistical analysis has been applied. In (A) each group shows the distribution of the fastest out of 100 molecules; in (B) 1000 molecules and in (C) 10,000 molecules. The set of travel times was comprised of travel times from each group having a ranking of first (i.e., the shortest travel times of each group).

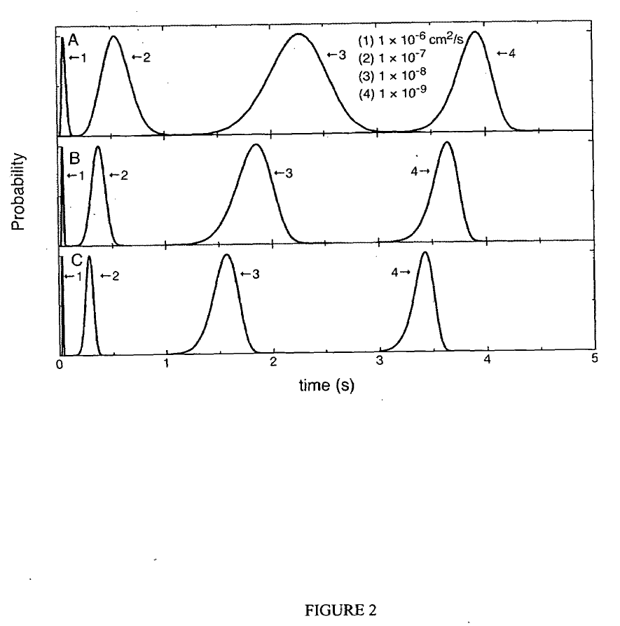

FIG. 3 depicts output signals from two analytes (1) and (2) having similar diffusion coefficients (D) in units of cm²/s, both before application of extreme value statistical analysis (A) and after application of extreme value statistical analysis (B).

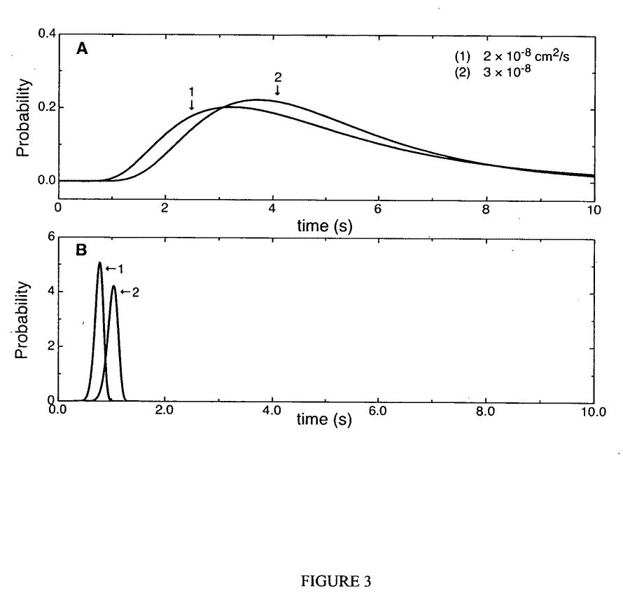

FIG. 4 depicts a plot of the confidence interval on the y-axis vs. the heat size on the x-axis. The confidence interval corresponds to the probability that the parameters falls within a specified interval.

FIG. 5 depicts an analysis of an unseparated, multi-component mixture comprising two analytes, alpha and beta. The plot (A) shows the distribution of crossing times from the mixture of the components. The plot (B) shows the distribution from the fastest out of 64 molecules; in this case, the distribution comes solely from analyte alpha, there is no analyte beta in the plot. The plot (C) shows the distribution from the 20^{th} fastest out of 64 molecules; here the distribution arises from a mixture of the two components.

FIG. 6(a) depicts the mean and standard deviation of the fastest travel times in each of 16 groups, each comprising the traveltimes of 100 individual fluorescent microspheres. FIG. 6(b) depicts a plot of the crossing times of individual fluorescent microspheres crossing between two probes. In both Figures, the y-axis is the number of fluorescent microspheres, or frequency, and the x-axis is time in milliseconds. The data was taken from Schiro, P. G. et al., “Continuous-flow single-molecule CE with high detection efficiency,” Electrophoresis 2007, vol 28, issue 14, pp. 2430-2438.

### DETAILED DESCRIPTION OF THE INVENTION

In all embodiments of the present invention, all numerical amounts are understood to be modified by the word “about” unless otherwise specifically indicated. Where applicable, “about” is understood to mean ±10% of a given value. All ranges are inclusive and combinable. All documents cited in the Detailed Description of the Invention are, in relevant part, incorporated herein by reference; however, the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

The present invention describes a method of reducing peak width in flow-through analytical instrumentation. The analytical instrumentation is understood herein to encompass any instrumentation having a time resolution component, non-limiting examples of which include chromatography (e.g., gas, liquid and/or thin layer chromatography), electrophoresis (e.g., capillary and/or gel), flow cytometry, mass spectrometry and any combinations thereof. In one embodiment, the analytical instrumentation comprises a chromatograph, an electrophoresis apparatus, a flow cytometer, a mass spectrometer, or combinations thereof. In one embodiment, the analytical instrumentration is a flow cytometer.

The instrument must be capable of recording the time required for an individual analyte within a sample to travel a known distance (d) between a first point and a second point. At least one of the first and the second points is a detector capable of single molecule detection, meaning that the detector must be capable of distinguishing the occurrence of a single event without interference from another similar event. Once the analyte enters the detection the timing device is initiated. After the analyte has left the detection area, the timing circuit is stopped. The travel time, or crossing time, is thus the difference of the two measurements. Herein, “event” is understood to mean detection of an analyte of interest such as a molecule, a particle, a fragment (e.g., a fragment of a peptide or DNA), etc. Herein, an “analyte” is understood to mean molecules, particles and/or fragments of the same chemical moiety. For example, a sample comprising chemical moieties A, B and C may be said to comprise analytes A, B and C. “Individual analyte” is understood to mean a single molecule, particle, and/or fragment within, for example, analyte A. The detection of the analyte may be understood to be detection of a signal originating from the analyte (e.g., fluorescence, Raman scattering), or from the analyte coming into contact with the detector. In one embodiment, the instrument has at least two detectors capable of single molecule detection. There is no requirement that the detectors be of the same type; however, the combination of detectors must have the capability to detect the time required for individual analytes to travel from the first detector to the second. Non-limiting examples of suitable detectors include a fluorescence detector, an ultraviolet detector, an infrared radiation detector, a photomultiplier tube, a charge coupled device (CCD), an electron capture detector, a gamma ray detector, and combinations thereof. In one embodiment, the detector is selected from the group consisting of a fluorescence detector, a charge coupled device, and combinations thereof. Examples of instruments suitable for use in the method of the present invention are described in Van Orden et al., “Efficient Detection of Single DNA Fragments in Flowing Sample Streams by Two-Photon Fluorescence Excitation,” Anal. Chem. 1999, vol. 71, pp. 2108-2116; Van Orden et al., “High-Throughput Flow Cytometric DNA Fragment Sizing,” Anal. Chem. 2000, vol. 72, pp. 37-41; and in Van Orden, A. and Keller, R. A., “Fluorescence Correlation Spectroscopy for Rapid Multicomponent Analysis in a Capillary Electrophoresis System,” Anal. Chem. 1998, vol. 70, pp. 4463-4471.

In an alternative embodiment, the instrument comprises one detector and one timing imitating device, wherein the timing initiating device need not necessarily be capable of detecting an analyte, but rather initiates a timed event. One non-limiting example of a suitable timing initiating device is a laser. The timing initiating device may induce a detectable change in the analyte. For example, a laser may induce fluorescence in an analyte, which may then be detected after traveling a distance to a fluorescence detector.

The travel times of the individual analytes are recorded and are divided into groups comprising a fixed number of travel times. The division into groups may be performed by a variety of means. In one embodiment, division into groups may occur on a random basis, after generation of all data. Alternatively, the division into groups is performed sequentially. For example, if the groups are to comprise about 100 molecules each, then the first 100 molecules to pass the detector may comprise the first group, the next 100 molecules to pass the detector may comprise the second group, and so on

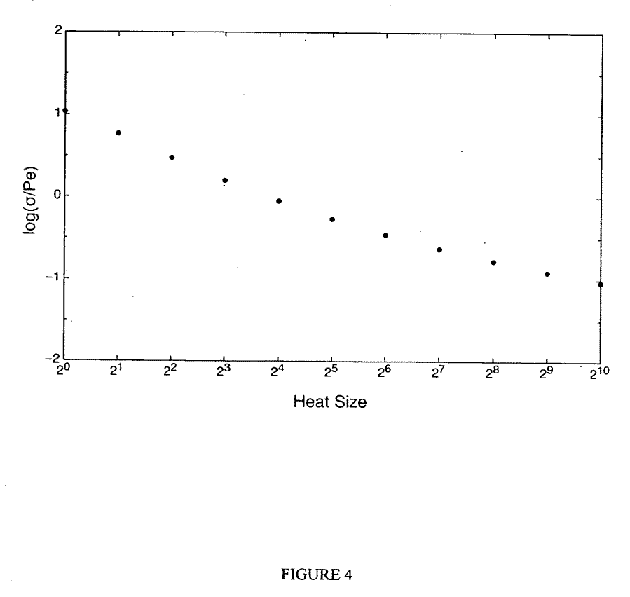

By “fixed number of travel times,” or “fixed number of crossing times,” is meant that a number of detected travel times corresponding to a number of analytes is chosen for a given data analysis. The choice of number depends in part on the desired narrowing of the peak width. Referring to FIG. 4, as the number of travel times in a group increases (i.e., as the “heat size” increases), the resulting peak width decreases. By selecting an appropriate number for a group whose selection is dictated by the experiment, the peak width can decreased by approximately 10 times as shown in FIG. 4. When the number of travel times in a group is from about 1 to about 100, or alternatively less than 100, the resulting peak width may be about ten times the peak width that results when the number of travel times in a group is greater than 100. In one embodiment, the fixed number of travel times is less than about 100, alternatively is from about 1 to about 100, alternatively is from about 100 to about 1,000, alternatively is from about 1,000 to about 10,000, alternatively is less than 10,000, and alternatively is greater than 10,000.

Within each group, the travel times are ranked in a given order. In one embodiment, the travel times within a group are ranked from fastest travel time to slowest travel time, in which case the fastest analyte (i.e. the analyte having the shortest travel time between the two detectors), is said to be ranked first (or to have a ranking of first), the second fastest analyte ranked second, etc.

From each group of travel times corresponding to an analyte, at least one travel time is selected. It is to be understood that the phrase “a set of selected travel times comprised of travel times having the same ranking,” is meant that the travel times within the set all had the same ranking in their respective groups from which they were selected. In one embodiment, the set of selected travel times is comprised of travel times having the same ranking. In one embodiment, the set of selected travel times is comprised of travel times that were ranked first within their respective groups (“ranked first”), alternatively that were ranked second, and alternatively that were ranked at least third. The distribution of the set of selected travel times, i.e. an histogram, may be plotted to produce an output signal in the form of a peak.

In one embodiment, extreme value statistics may be applied to the set of selected travel times prior to producing an output signal in the form of a peak. In another embodiment, less precise than the former, mean and the standard deviation of the set of selected travel times may be calculated prior to producing an output signal in the form of a peak. The output signal may be produced by plotting a histogram of the travel times to result, for example, in time on the x-axis vs. probability on the y-axis.

The following describes one example of applying extreme value statistics in accordance with the present invention. The extreme value distribution (p_{j/n}(t)) of the jth analyte may be calculated using the following equation (1) to produce an output; where “j” is the ranking of the analyte, and the jth analyte thus can be the first, second, third, . . . nth analyte in each set of travel times.

$$\begin{matrix}\text{:} & ( 1 ) \\ {p}_{j / n} ( t ) = ( \frac{n !}{( n - j ) ! ( j - 1 ) !} ) {C ( t )}^{j - 1} P ( t ) {( 1 - C ( t ) )}^{n - j} & \end{matrix}$$

where n is the fixed number of travel times in a group, and P(t) is

$$P ( t ) = \frac{d}{\sqrt{4 π {Dt}^{3}}} Exp [ - \frac{{( vt - d )}^{2}}{4 Dt} ] , \qquad ( 2 )$$

### and C(t) is

$$C ( t ) = \frac{1}{2} ( 1 + Erf [ \frac{vt - d}{\sqrt{4 Dt}} ] + Exp [ \frac{dv}{D} ] Erfc [ \frac{vt + d}{\sqrt{4 Dt}} ] ) , \qquad ( 3 )$$

where t is the time in seconds (s), v is the velocity of the flow in cm/s, d is the distance to the detector in cm, D is the diffusion coefficient in cm²/s, Erf is the error function and Erfc is the complementary error function.

Extreme statistical analysis as described herein may be applied to a single component system, to a separated multi-component system, and/or to an unseparated multi-component system. Herein, “single component system” is understood to mean a sample having a single analyte; “separated multi-component system” is understood to mean a sample comprising at least two analytes that are separated prior to detection in the flow-through system (for example, by means of a chromatographic column) or alternatively, a mixture that has distinct tags for each molecule that allows one to distinguish each analyte during detection; and “unseparated multi-component system” is understood to mean a sample comprising at least two analytes which is not separated prior to detection in the flow-through system. For a single component system or for a separated multi-component system, Equation (1) can be used for j=1 to give an estimation of the peak width that is approximately 10 times smaller than if no selection of the jth analyte occurs, in which case the entire set of data would be fitted only to Equation (2). This is evidenced by FIG. 4, in which the y-axis correlates to the peak width and the x-axis represents the fixed number of travel times in a group.

For an unseparated multi-component system, including a sample in which the user may not know that the sample contains more than one analyte of interest, Equation (1) may be modified in the following manner to replace p_{j/n}(t) with:

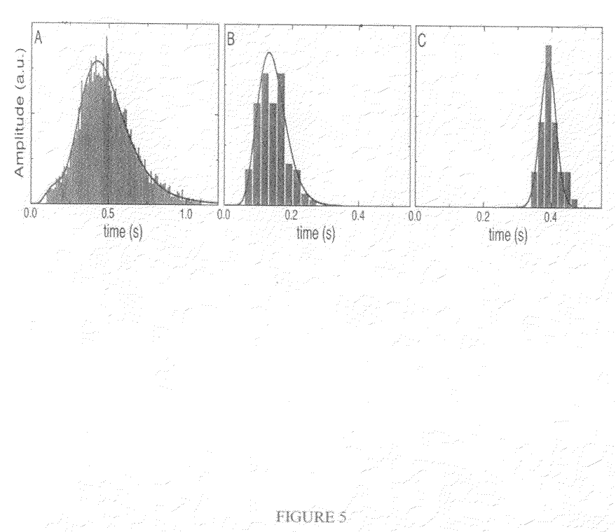

Xp^{α}_{j/n}(t)+(1−X)p^{β}_{j/n}(t), (4)

where X is the molar fraction of component alpha, and the superscripts represent components alpha and beta respectively. In such a system, the shortest travel times in each group correspond to the analyte with the largest diffusion coefficient (D) (“first analyte,” alpha). To determine the concentration and the diffusion coefficient of the first analyte in the sample, equation (1) may be used with a value of j=1 to determine n and D for the first analyte. The concentration of analyte alpha is the determined value for n divided by the original number of selected travel times in the group. Subsequent travel times in the group, j>1, can be analyzed using Equation (4) along with the determined values of X and D for component alpha, to determine D for component beta. An example of the output of the above procedure is depicted in FIG. 5. Referring to FIG. 5, the bars correspond to simulated data that represent a set of travel times comprising 6400 total simulated points of an unseparated, multi-component mixture comprising two analytes, alpha and beta. The lines correspond to fits of the data. The simulation parameters were as follows: d=0.001 cm, v=0.002 cm/s, the ratio (molar fraction) of alpha:beta was 0.76, and D=5×10⁷ and 10⁻⁷ cm²/s for alpha and beta, respectively. (A) represents the complete set of all of the travel times without any selection. The value of the fitted molar fraction was 0.20±0.04, and the D values were 6.57±1.97×10⁻⁷ and 0.99±0.06×10⁻⁷ cm²/s for alpha and beta respectively. (B) represents the original data set divided into 100 groups of 64. The analyte that ranked first in each group were fit and the molar fraction was determined to be 0.23±0.05, and D for component alpha was determined to be 5.00±0.06×10⁻⁷ cm²/s. In (C) the species that ranked 20^{th} in each group was fit using the parameters obtained in (B) to determine D for component beta. The fit gave a value of D for component beta of 0.94±0.03×10⁻⁷ cm²/s. It should also be understood that the above procedure may be repeated in an iterative manner to extend to multiple components.

It should be noted that unseparated multi-component mixtures may comprise components that have differences in the diffusion constant, may comprise components with the same diffusion constant but different velocities can also be statistically separated, or may be any combination thereof. In addition, separation is not limited to only the “first place finisher” in each heat. For example, statistical separation can occur for the “last place” finisher or a “mid-place finisher,” etc., as long as the selected finisher in each heat is consistent. It is important to note that the separation is virtual and occurs only in the data stream, there is no real physical separation. Although the separation is virtual, being able to determine the physical parameters of individual analytes of the mixture without any separation chemistry is particularly useful.

### EXAMPLES

### Example 1

### Analysis of a Single Component Mixture

Transit times of at least 2000 individual fluorescent microspheres crossing between two different probe regions, separated by 11 μm, were recorded. The data were acquired in a series of measurements to determine the fraction of beads exiting Probe Region 1 that were subsequently detected in Probe Region 2 by the method described in Schiro, P. G. et al., “Continuous-flow single-molecule CE with high detection efficiency,” Electrophoresis 2007, vol 28, issue 14, pp. 2430-2438, incorporated in its entirety herein by reference. The time that it takes to travel between the two probe regions was approximately 1 ms.

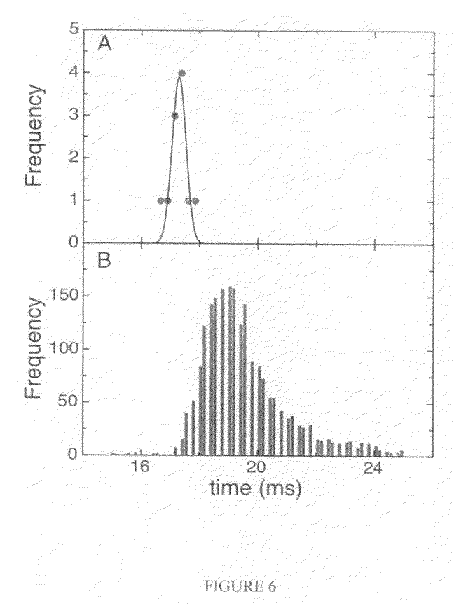

FIG. 6b shows a plot of the crossing times of the individual microspheres. Points with transit times less than 15 ms or greater than 25 ms are outliers were removed. Removing the outliers had minimal effects on the data set, as the mean value of the data set was unchanged. The sample was divided into 16 heats of 100 crossings. This required 1600 points. The mean and the standard deviation of fastest crossing times in each of the 16 heats was used to calculate the Gaussian distribution that represented the winners of the 16 heats (see FIG. 6a). The mean and standard deviation of the 16 winners are 17.29 and 0.23 ms, respectively, whereas the mean and standard deviation for the entire set of data was calculated to be 19.54 and 1.45 ms, respectively.

### Example 2

### Analysis of an Unseparated, Multi-Component Mixture

A mixture of two components, A and B may be analyzed using single molecule chromatography as follows. Single analyte molecules are allowed to flow through two detectors according to the method described in Schiro, P. G. et al., “Continuous-flow single-molecule CE with high detection efficiency,” Electrophoresis 2007, vol 28, issue 14, pp. 2430-2438, incorporated in its entirety herein by reference. The diffusion constants of A and B are 5×10⁻⁷ cm²/s and 1×10⁻⁷ cm²/s, respectively. The crossing distance is 1×10⁻³ cm, and the velocity is 2×10⁻³ cm/s. The data is separated into 1000 heats, each heat comprising from 2 to 128 data points which represent crossing times. The separation of the data into heats results in a statistical separation of species. By only considering the first crossing times in a group of heats one can statistically separate the component with the largest diffusion coefficient. A plot is created of the mole fraction of A for the first place finisher as a function of heat size. When the heat size exceeds 64, statistical separation occurs for the “first place finishers” of each heat.

The analysis assumes that the components are thoroughly mixed and enter the detection region in a random fashion and there is no feature that distinguishes individual species, that is, the detector cannot differentiate individual species, both species give identical signals. If the components are not thoroughly mixed, then the data stream needs to be randomly “shuffled.”

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of reducing peak width in flow-through analytical instrumentation measurements, comprising:
a) introducing a sample into an analytical instrument;
b) recording the time required for a plurality of individual analytes within the sample to travel a known distance between a first point and a second point within the analytical instrument to produce a plurality of travel times;
c) dividing the travel times into a plurality of groups comprising a fixed number of travel times;
d) assigning a ranking to the travel times within a group;
e) selecting from each group at least one travel time to produce a set of selected travel times; and
f) producing from the set of selected travel times an output signal in the form of a peak.

2. The method of claim 1, further comprising the step of applying extreme value statistical analysis to the set of selected travel times.

3. The method of claim 1, further comprising the step of calculating the mean and the standard deviation of the set of selected travel times.

4. The method of claim 1, wherein the ranking is in the order shortest travel time to longest travel time.

5. The method of claim 1, wherein the set of selected travel times is comprised of travel times having the same ranking.

6. The method of claim 5, wherein the ranking is first.

7. The method of claim 1, wherein the fixed number of travel times is less than 100.

8. The method of claim 1, wherein the fixed number of travel times is from about 100 to about 1000.

9. The method of claim 1, wherein the fixed number of travel times is about 10,000 or less.

10. The method of claim 1, wherein the flow-through analytical instrumentation comprises a chromatograph, an electrophoresis apparatus, a flow cytometer, a mass spectrometer, or combinations thereof.

11. The method of claim 10, wherein the flow-through analytical instrumentation is a flow cytometer.

12. The method of claim 1, wherein at least one of the first and the second points is a single molecule detector selected from the group consisting of a fluorescence detector, an ultraviolet detector, an infrared radiation detector, a photomultiplier tube, a charge coupled device, an electron capture detector, a gamma ray detector, and combinations thereof.

13. The method of claim 12, wherein the single molecule detector is selected from the group consisting of a charge coupled device, a fluorescence detector, and combinations thereof.

14. The method of claim 1, wherein at least one of the first and the second points is a timing initiating device.

15. The method of claim 1, wherein the sample is a single component system.

16. The method of claim 1, wherein the sample is a separated multi-component system.

17. The method of claim 1, wherein the sample is an unseparated multi-component system.
